(19) United States
(12) Patent Application Publication
(10) Pub. No.: US 2019/0288573 A1
(43) Pub. Date: Sep. 19, 2019

(54) ROTOR OF ROTARY ELECTRIC MACHINE

(71) Applicant: HONDA MOTOR CO., LTD., Tokyo (JP)

(72) Inventor: Tadanobu TAKAHASHI, Saitama (JP)

(73) Assignee: HONDA MOTOR CO., LTD., Tokyo (JP)

(21) Appl. No.: 16/351,779

(22) Filed: Mar. 13, 2019

(30) Foreign Application Priority Data
Mar. 15, 2018 (JP) 2018-048500

(51) Int. Cl. H02K 1/27; H02K 7/00

(52) U.S. Cl. CPC H02K 1/2713; H02K 7/003

(57) ABSTRACT

A rotor of a rotary electric machine includes a rotor core, and a rotor shaft configured to rotate integrally with the rotor core. The rotor core includes a plurality of magnet insertion holes disposed in a circumferential direction, each of the magnet insertion holes extending axially in the rotor core, and a plurality of through holes disposed in the circumferential direction, each of the through holes extending axially in the rotor core. A plurality of magnets are disposed in the magnet insertion holes, a plurality of strength pins are disposed in the through holes, and the plurality of strength pins are supported by a support plate interposed in the rotor core.

### CROSS-REFERENCE TO RELATED APPLICATIONS

The present application claims the benefit of priority of Japanese Patent Application No. 2018-048500, filed on Mar. 15, 2018, the content of which is incorporated herein by reference.

### TECHNICAL FIELD

The present invention relates to a rotor of a rotary electric machine mounted on an electric vehicle or the like.

### BACKGROUND ART

In recent years, higher rotation speed and high output are desired in a rotary electric machine that is used as a drive source of a hybrid vehicle or an EV vehicle. With the higher rotation speed of the rotary electric machine, a rotor of a rotary electric machine tends to become longer in an axial direction. A magnet is embedded in the rotor, and accordingly, a centrifugal force acting on the magnet causes a stress to act on a rotor core to expand radially outward. Therefore, higher strength of the rotor core is required for the higher rotation speed of the rotary electric machine.

FIG. 8 illustrates a rotor core 100 of a permanent magnet rotary electric machine described in JP-A-2013-81302 In the rotor core 100, permanent magnets 103 are disposed respectively in a pair of magnet insertion holes 102 provided across a bridge portion 101 to form a magnetic pole 104. Rotational strength of the rotor core 100 is ensured by the bridge portion 101 between the pair of magnet insertion holes 102.

However, in JP-A-2013-81302, magnetic flux cannot be effectively used since magnetic flux would leak through the bridge portion 101 that ensures the strength of the rotor core 100, which may result in a reduced motor torque.

### SUMMARY

Accordingly, an aspect of the present invention provides a rotor of a rotary electric machine capable of improving magnetic torque and reluctance torque while improving rotational strength of the rotor.

According to an embodiment of the present invention, there is provided a rotor of a rotary electric machine that includes a rotor core and a rotor shaft configured to rotate integrally with the rotor core. The rotor core includes: a plurality of magnet insertion holes disposed in a circumferential direction, each of the magnet insertion holes extending axially in the rotor core; and a plurality of through holes disposed in the circumferential direction, each of the through holes extending axially in the rotor core. A plurality of magnets are disposed in the magnet insertion holes, a plurality of strength pins are disposed in the through holes, and the plurality of strength pins are supported by a support plate interposed in the rotor core.

According to the above configuration, the plurality of strength pins are disposed in the through holes provided in the rotor core to penetrate the rotor core in the axial direction. Therefore, it is possible to prevent deformation of the rotor even when a centrifugal force acts on the magnets due to rotation of the rotor. Accordingly, rotational strength and magnetic flux passage of the rotor can be set separately, so that magnetic torque and reluctance torque can be improved. Further, since the strength pins are supported by the support plate interposed in the rotor core, the strength pins can be thinner and an area of the rotor core can be ensured larger.

### BRIEF DESCRIPTION OF DRAWINGS

FIG. 1 is a perspective view of a rotor of a rotary electric machine according to an embodiment of the present invention.

FIG. 2 is a cross-sectional view taken along a line A-A in FIG. 1.

FIG. 3 is a perspective view illustrating the rotor of the rotary electric machine in FIG. 1 in which a rotor core is removed.

FIG. 4 is a perspective view illustrating the rotor of the rotary electric machine in FIG. 1 in which a pair of end plates are removed.

FIG. 5 is a perspective view of a support plate.

FIG. 6 is a front view of the rotor core.

FIG. 7 is a partial enlarged view of the rotor core in FIG. 6.

FIG. 8 is a partial enlarged view of a rotor core in JP-A-2013-81302.

### DESCRIPTION OF EMBODIMENTS

A rotor of a rotary electric machine according to an embodiment of the present invention is described below with reference to the accompanying drawings.

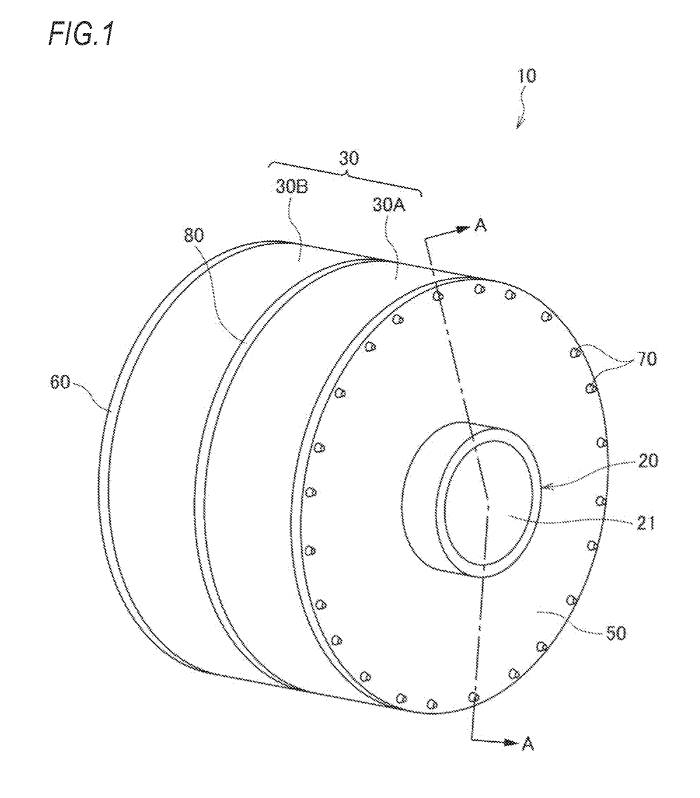

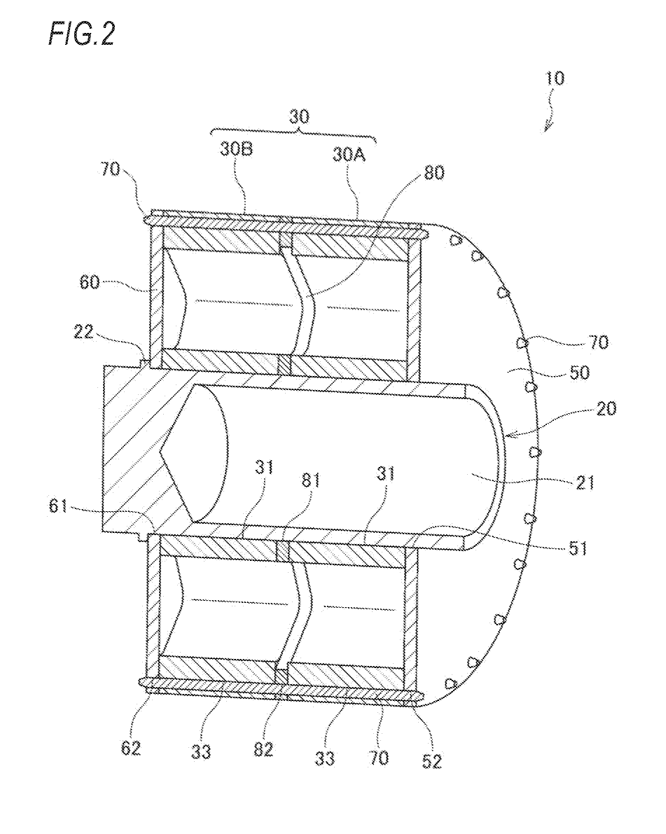

As illustrated in FIGS. 1 and 2, a rotor 10 of a rotary electric machine according to the present embodiment includes a rotor shaft 20, a rotor core 30 axially supported by the rotor shaft 20, a first end plate 50 disposed on one side of the rotor core 30 in an axial direction, a second end plate 60 disposed on another side of the rotor core 30 in the axial direction, a plurality of strength pins 70, and a support plate 80.

The rotor shaft 20 includes an axial hole 21 in a central portion thereof, and a positioning portion 22 at an end portion (left end portion in FIG. 2) thereof.

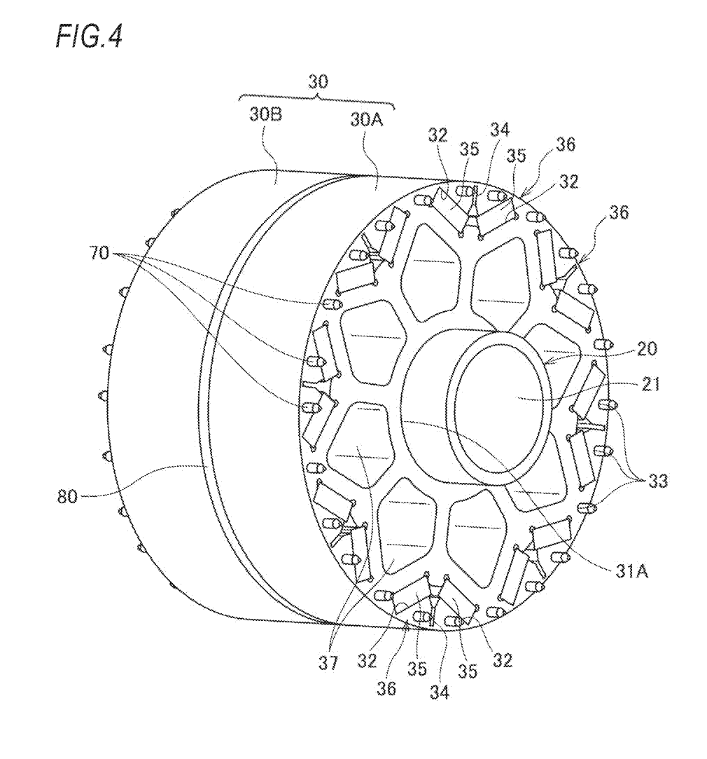

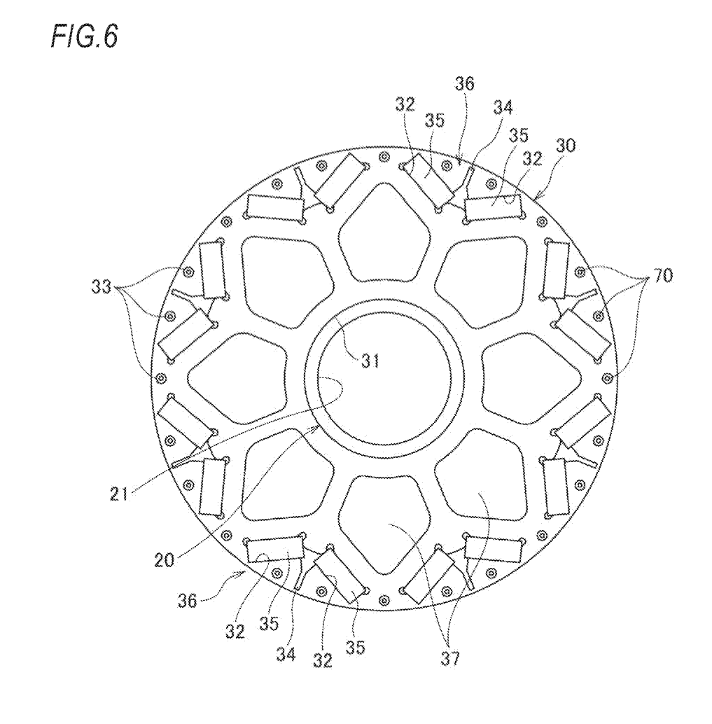

Referring also to FIGS. 4 and 6, the rotor core 30 includes a pair of rotor core portions 30A, 30B configured by a plurality of laminated annular electromagnetic steel plates.

The pair of rotor core portions 30A, 30B include a rotor insertion hole 31 penetrating a center thereof in the axial direction. The pair of rotor core portions 30A, 30B have the same shape and approximately the same thickness (axial length). In the rotor core 30, the rotor shaft 20 is press-fitted and fixed to the rotor insertion hole 31 with the support plate 80 interposed between the pair of rotor core portions 30A, 30B.

The rotor core 30 includes a plurality of axially extending magnet insertion holes 32 and a plurality of axially extending through holes 33 disposed in a predetermined pattern in a circumferential direction. The magnet insertion holes 32 are formed in a substantially V-shape opening toward an outer diameter side of the rotor core 30. A groove 34 extending toward the outer diameter side is continuously formed in a center of the magnet insertion hole 32 in the circumferential direction. Further, on an inner diameter side than the magnet insertion holes 32, a plurality of axial holes 37 are disposed for weight reduction to penetrate the rotor core 30 in the axial direction. The axial hole 37 has a substantially pentagonal cross section.

A magnet 35 is disposed in each of the plurality of magnet insertion holes 32. A pair of magnets 35 disposed in the magnet insertion hole 32 forms a magnetic pole 36. That is, the same number of magnetic poles 36 as the magnet insertion holes 32 are provided in the rotor core 30 at a predetermined interval in the circumferential direction.

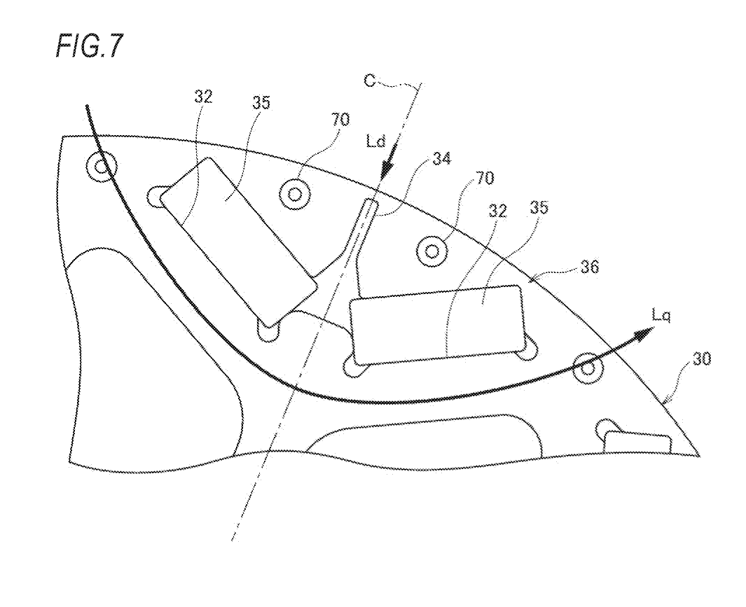

The plurality of through holes 33 are disposed at the same radial position (the same circumference) on the outer diameter side than the magnet insertion holes 32. The through holes 33 are disposed symmetrically with respect to the magnet insertion hole 32, that is, to a center C (see FIG. 7) of the magnetic pole 36. Further, one through hole 33 is provided between adjacent magnet insertion holes 32, that is, between two magnetic poles 36.

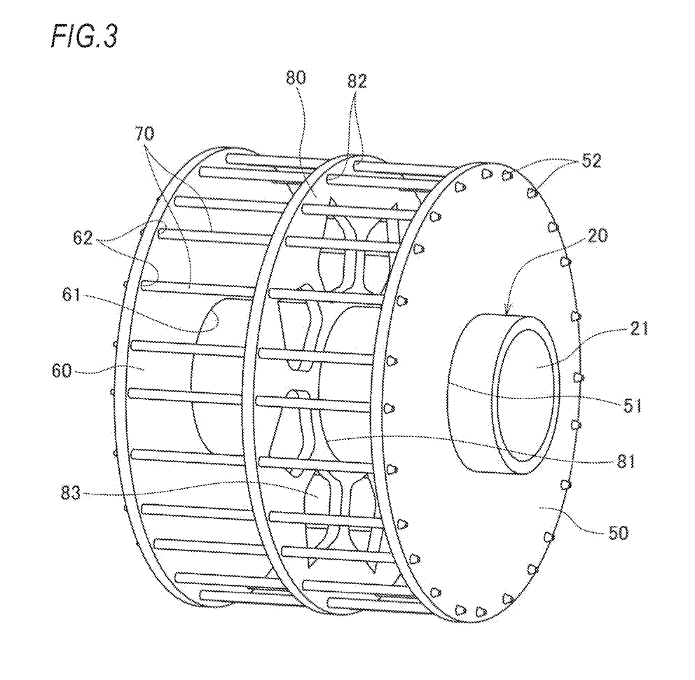

As illustrated in FIG. 3, rotor shaft holes 51, 61 are respectively formed in centers of the first end plate 50 and the second end plate 60 sandwiching the rotor core 30. On the outer diameter side, a plurality of through holes 52, 62 are formed corresponding to the plurality of through holes 33 of the rotor core 30.

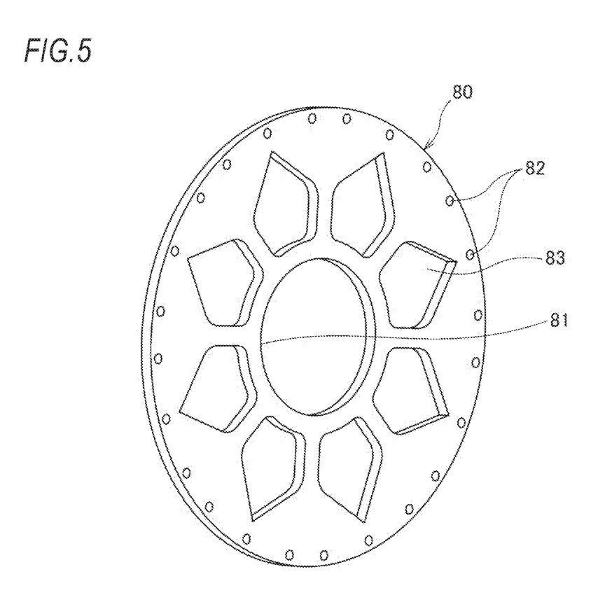

As illustrated in FIGS. 3 and 5, the support plate 80 has a disk shape formed of a non-magnetic material and has the same outer diameter as the rotor core 30, the first end plate 50 and the second end plate 60. The support plate 80 includes a rotor shaft hole 81 in a center thereof. The support plate 80 includes a plurality of through holes 82 on an outer peripheral side thereof. The through holes 82 are formed on the same phase/interval and the same circumference as the plurality of through holes 33 of the rotor core 30. Further, the support plate 80 includes a plurality of through holes 83 having substantially the same shape as the axial holes 37 in positions corresponding to the axial holes 37 of the rotor core 30.

As illustrated in FIG. 2, the support plate 80 is sandwiched between the pair of rotor cores portions 30A, 30B, and the first end plate 50 and the second end plate 60 are disposed on both sides of the rotor core 30 in the axial direction. In this state, the rotor shaft 20 is inserted and assembled in the rotor shaft hole 51 of the first end plate 50, the rotor insertion hole 31 of the rotor core portion 30A, the rotor insertion hole 31 of the rotor core portion 30A, the rotor shaft hole 81 of the support plate 80, the rotor insertion hole 31 of the rotor core portion 30B, and the rotor shaft hole 61 of the second end plate 60. The second end plate 60 abuts on the positioning portion 22 of the rotor shaft 20.

The strength pins 70 are inserted into the through holes 52 of the first end plate 50, the through holes 33 of the rotor core portion 30A, the through holes 82 of the support plate 80, the through holes 33 of the rotor core portion 30B, and the through holes 62 of the second end plate 60. Both ends of the strength pins 70 are fixed to the first end plate 50 and the second end plate 60 by crimping or welding.

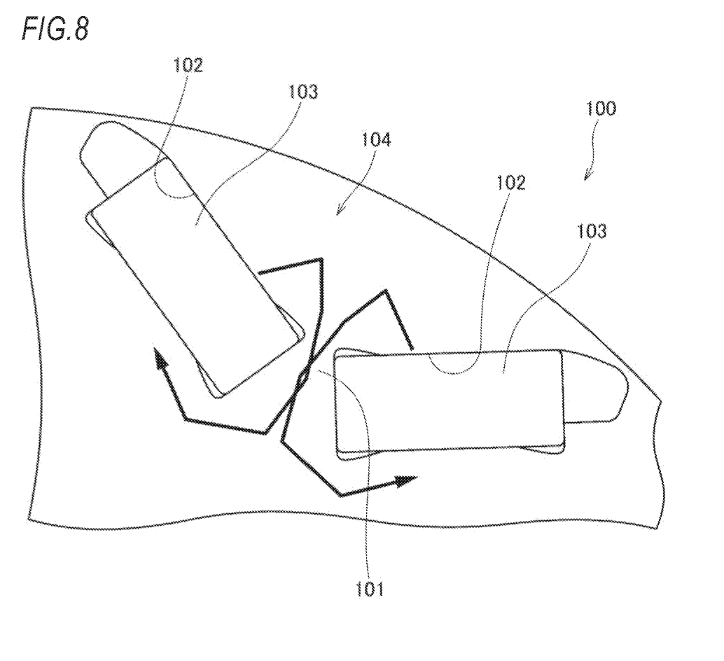

As illustrated in FIG. 7, the rotor core 30 according to the present embodiment does not include the bridge portion 101 (see FIG. 8) that is conventionally provided to ensure rotational strength. Instead, the rotor core 30 includes, in a part where the bridge portion 101 is provided, the groove 34 extending from the magnet insertion holes 32 toward the outer diameter side. An air layer in the groove 34 acts as a magnetic shield that reduces reluctance torque Ld of a d-axis.

By minimizing the reluctance torque Ld of the d-axis, a salient ratio can be maximized, thereby maximizing torque generated by the rotary electric machine. Further, since the rotor core 30 according to the present embodiment does not include the bridge portion 101, it is possible to prevent magnetic flux leakage around the permanent magnets 103 due to the bridge portion 101, which is indicated by the arrow in FIG. 8.

The strength pins 70 held by the first and second end plates 50, 60 are respectively inserted into the plurality of through holes 33 provided on the outer diameter side than the magnet insertion holes 32, while middle parts of the through holes 33 are supported via the through holes 82 of the support plate 80. Therefore, a centrifugal force that acts on the magnet 35 along with rotation serves as a force that deforms the rotor core 30 toward the outer diameter side, but is received by the strength pins 70. Accordingly, rotation strength of the rotor core 30 is not deteriorated even without the bridge portion 101, and deformation of the rotor core 30 is prevented.

The strength pins 70 have a three-point support structure in which both the end portions thereof are supported by the first and second end plates 50, 60 and center portions thereof are supported by the support plate 80. Accordingly, an interval between support points can be shorter and an axial length of the rotor core 30 can be longer. Further, a diameter of the strength pins 70 can be smaller and an area of the rotor core 30 can be increased, so that deformation of the rotor core 30 is prevented.

Since the strength pins 70 are disposed symmetrically in the circumferential direction with respect to the center C of the magnetic pole 36 and the support plate 80 is disposed at an axial center portion of the rotor core 30, an imbalance of the rotor core 30 occurred during rotation can also be prevented.

In this way, a measure for improving the rotational strength of the rotor core 30 and a measure for improving magnetic characteristics can be carried out separately, so that degree of freedom of design is improved. Therefore, according to the present embodiment, it is possible to improve magnetic torque and reluctance torque while improving the rotational strength of the rotor core 30.

The above embodiment may be appropriately modified, improved, or the like. For example, although the magnetic pole 36 in the above embodiment is formed by a pair of magnets 35 disposed in one magnet insertion hole 32, the magnetic pole 36 may also include a bridge portion. That is, a magnetic pole may be formed by a pair of magnets disposed in a pair of magnet insertion holes provided across the bridge portion. Further, one magnetic pole may be formed by one magnet, or by three or more magnets.

At least the following matters are described in the present specification. Although corresponding constituent elements or the like in the above-described embodiment are illustrated in parentheses, the present invention is not limited thereto.

(1) A rotor of a rotary electric machine (rotor 10 of rotary electric machine) includes:

a rotor core (rotor core 30); and

a rotor shaft (rotor shaft 20) configured to rotate integrally with the rotor core,

wherein the rotor core includes:
a plurality of magnet insertion holes (magnet insertion holes 32) disposed in a circumferential direction, each of the magnet insertion holes extending axially in the rotor core; and
a plurality of through holes (through holes 33) disposed in the circumferential direction, each of the through holes extending axially in the rotor core,

wherein a plurality of magnets (magnets 35) are disposed in the magnet insertion holes,

wherein a plurality of strength pins (strength pins 70) are disposed in the through holes, and

wherein the plurality of strength pins are supported by a support plate (support plate 80) interposed in the rotor core.

According to (1), the plurality of strength pins are disposed in the through holes provided in the rotor core to penetrate the rotor core in the axial direction. Therefore, it is possible to prevent deformation of the rotor even when a centrifugal force acts on the magnets due to rotation of the rotor. Accordingly, rotational strength and magnetic characteristics of the rotor can be set separately, so that magnetic torque and reluctance torque can be improved. Further, since the strength pins are supported by the support plate interposed in the rotor core, the strength pins can be thinner and an area of the rotor core can be ensured larger.

(2) In the rotor according to (1),

the rotor includes a plurality of magnetic poles (magnetic poles 36) disposed in the circumferential direction,

each of the magnetic poles is formed by a pair of magnets, and

the pair of magnets of each of the magnetic poles is disposed in respective one of the magnet insertion holes.

According to (2), since the pair of magnets of each of the magnetic poles is disposed in respective one of the magnet insertion holes, a bridge portion is not necessary between the pair of magnets. That is, deformation of the rotor core is prevented even without the bridge portion since strength of the rotor core is ensured by the strength pins. Further, magnetic flux leakage through the bridge portion can be prevented by eliminating the bridge portion, so that magnetic flux can be effectively used. This improves output of the rotary electric machine.

(3) In the rotor according to (1) or (2),

a pair of end plates (end plates 50, 60) are provided at both end portions of the rotor core, and

the strength pins are fixed to the pair of end plates.

According to (3), the end plates can be used as support portions of the strength pins.

(4) In the rotor according to any one of (1) to (3),

the strength pins are disposed on an outer peripheral side of the magnets.

According to (4), since the strength pins are disposed on the outer peripheral side of the magnets, deformation of the rotor can be effectively prevented even when the centrifugal force acts on the magnets due to the rotation of the rotor.

(5) In the rotor according to any one of (1) to (4),

a pair of strength pins are provided for each magnetic pole, and

the pair of strength pins are disposed symmetrically with respect to a center of the magnetic pole (center of magnetic pole C).

According to (5), it is possible to prevent an imbalance in the rotor core.

(6) In the rotor according to any one of (1) to (5), the support plate is formed of a non-magnetic material.

According to (6), it is possible to prevent an influence on magnetic characteristics due to the support plate.

(7) In the rotor according to any one of (1) to (6), the support plate is disposed in an axial center portion of the rotor core.

According to (7), since the support plate is disposed in the axial center portion of the rotor core, it is possible to prevent an imbalance in the rotor core.

1. A rotor of a rotary electric machine, comprising:
a rotor core; and
a rotor shaft configured to rotate integrally with the rotor core,
wherein the rotor core includes:
a plurality of magnet insertion holes disposed in a circumferential direction, each of the magnet insertion holes extending axially in the rotor core; and
a plurality of through holes disposed in the circumferential direction, each of the through holes extending axially in the rotor core,
wherein a plurality of magnets are disposed in the magnet insertion holes,
wherein a plurality of strength pins are disposed in the through holes, and
wherein the plurality of strength pins are supported by a support plate interposed in the rotor core.

2. The rotor according to claim 1,
wherein the rotor includes a plurality of magnetic poles disposed in the circumferential direction,
wherein each of the magnetic poles is formed by a pair of magnets, and
wherein the pair of magnets of each of the magnetic poles is disposed in respective one of the magnet insertion holes.

3. The rotor according to claim 1,
wherein a pair of end plates are provided at both end portions of the rotor core, and
wherein the strength pins are fixed to the pair of end plates.

4. The rotor according to claim 1,
wherein the strength pins are disposed on an outer peripheral side of the magnets.

5. The rotor according to claim 1,
wherein a pair of strength pins are provided for each magnetic pole, and
wherein the pair of strength pins are disposed symmetrically with respect to a center of the magnetic pole.

6. The rotor according to claim 1,
wherein the support plate is formed of a non-magnetic material.

7. The rotor according to claim 1,
wherein the support plate is disposed in an axial center portion of the rotor core.
